(19) United States
(12) Patent Application Publication
(10) Pub. No.: US 2014/0122078 A1
(43) Pub. Date: May 1, 2014

(54) Low Power Mechanism for Keyword Based Hands-Free Wake Up in Always ON-Domain

(71) Applicant: 3iLogic-Designs Private Limited, Gurgaon (IN)

(72) Inventors: Amit Joshi, Gurgaon (IN); Pankaj Pailwar, Bangalore (IN)

(73) Assignee: 3iLogic-Designs Private Limited, Gurgaon (IN)

(21) Appl. No.: 14/010,341

(22) Filed: Aug. 26, 2013

(30) Foreign Application Priority Data
Nov. 1, 2012 (IN) 3357/DEL/2012

(51) Int. Cl. G06F 1/32; G10L 15/00

(52) U.S. Cl. CPC G06F 1/3206; G10L 15/00
USPC 704/251

(57) ABSTRACT

A low power keyword based speech recognition hardware architecture for hands free wake up of devices is provided. This system can be used in always ON domain for detection of voice activity, due to its low power operational ability. The system goes into deep low power state by deactivating all the non-required processes, if no activity is detected for a pre-specified time. Upon detection of the valid voice activity the system searches for the detection of the spoken keyword, if the valid keyword is detected, all the application processes are activated and system goes into full functional mode and if the voice activity doesn't contain the valid keyword present in the database then the system goes back into the deep low power state.

### CROSS-REFERENCE TO RELATED APPLICATIONS

This application claims priority to Indian Patent Application 3357/DEL/2012, filed Nov. 1, 2012, the disclosure of which is hereby incorporated by reference in its entirety.

### FIELD OF THE INVENTION

The present invention relates to a low power keyword based speech recognition scheme for hands free wakeup of devices. More specifically, the present invention relates to a low power keyword based speech recognition wake up scheme for hands free wakeup of devices that can be used in Always-ON domain by virtue of its very low power consumption.

### BACKGROUND OF THE RELATED ART

Speech recognition systems allow a user to control a device with speech recognition capability using natural language interface in a hands free manner.

Generally, in most devices like cell phones or PNDs, a user needs to use his/her hands in order to start interacting with the device—for instance, by pushing a button or by turning on the power delivered to the device. The electronic devices tend to move in a dormant state or “sleep mode” when not used for a pre-specified time. For example, mobile phones when not used for a pre-specified time, transition to a dormant state and remain there unless prompted by the user or any other external signal. The tendency of devices to move in “sleep mode” enables them to save significant amount of power.

However, waking up the device from sleep mode to an active state requires an input from the user terminal generally by turning on an external switch or pushing a button. For instance a cell phone in sleep mode comes out of it when any key is pressed by the user. Hence, to make these devices more convenient and user friendly, there is a need for a mechanism that allows hands free wake up of devices without the need for the user to turn on the switch or press the button every time.

Key word based wake up of devices is a new paradigm in speech recognition technology that enables the wakeup of devices such as cell-phones, PNDs and other devices using speech recognition technology or natural speech input. The system remains in sleep mode until a pre-specified keyword is enunciated by the user. Upon recognition of the keyword, the system transitions from the sleep mode to the active mode. Thus, the user activates the device using a spoken word or phrase that makes the device more convenient and easy to use.

However, systems incorporating speech recognition based wake up control must continuously hunt for any voice activity or continuously listen to any keyword uttered by the user in order to activate the device upon user's request. Since speech recognition is a computationally intensive technology requiring several million operations per second, this consumes significant amount of power and makes it impossible for the low power operated devices to keep the keyword based hands free voice detection system in an always active mode.

Moreover, software solutions for speech recognition are not particularly designed to be power efficient. They consume significant amounts of power during the time the device is looking for the spoken keyword. This is due to the fact that they have to run at an operating frequency of upwards of 100 MHz and also have to have a large DDR Memory footprint.

In light of the foregoing limitations, a keyword based speech recognition scheme for hands free wake up of devices is needed that consumes less power and remains in an Always-On domain to hunt for voice activity.

### BRIEF DESCRIPTION OF THE DRAWINGS

FIG. 1 is a block diagram for schematic representation of the hardware architecture for speech recognition in accordance with an embodiment of the present invention.

FIG. 2A is a block diagram representing the front end and its components in accordance with an embodiment of the present invention.

FIG. 2B is a block diagram representing the back end and its components in accordance with an embodiment of the present invention.

FIG. 3 is a schematic representation of the application processor that utilizes the speech recognition hardware system in accordance with an embodiment of the present invention. The highlighted region in FIG. 3 shows the active, Always ON domain region. This domain needs to always remain active in order to do voice activity detection.

FIG. 4 is a schematic representation of the application processor that utilizes the speech recognition hardware system in accordance with an embodiment of the present invention. The highlighted region in FIG. 4 shows the ON Domain for keyword detection after voice activity is detected where system works out of SRAM for keyword detection after the voice activity is detected.

FIG. 5 is a schematic representation of the application processor that utilizes the speech recognition hardware system in accordance with an embodiment of the present invention. The highlighted region in FIG. 5 shows the ON Domain for keyword detection after voice activity is detected where system works out of the DDR for keyword detection after the voice activity is detected.

FIG. 6 is a flowchart illustrating the mechanism for low power keyword based hands free wake-up in accordance with an embodiment of the present invention.

### DETAILED DESCRIPTION OF THE INVENTION

The present invention proposes a system and the mechanism for a keyword based hands free wake up that stays active all the time and consumes minimal amounts of power.

The keyword recognition approach is done in two stages that allow the system to go into a low power state while simultaneously hunting for voice activity. The hardware based scheme is embedded in the application processor chip that puts a segment of digital circuitry of the application processor in Always-ON domain enabling it to consume very little power while hunting for the voice while the rest segment of the application processor chip has been powered-off.

The system goes into a low power state if no activity is detected for a pre-specified time and the system is thus in idle state, by deactivating various modules of application processors.

At this state the back end clock to domain2 134 is stopped while lowering down the frequency of clock domain1 130 and domain3 132 up to quite a significant level, while still hunting for voice activity.

Upon detection of the voice activity there is a sudden escalation in the frequency of the clock to domain1 130 and domain3 132. Along-with this proliferation the clock to domain2 134 is activated and the system runs into the full activated mode if the detected voice signal is found to be a valid keyword.

However, if the detected voice activity or audio signal is found to be invalid i.e. do not match with the keyword in the database, then the system gets back into the low power mode, by shutting down all the unrequired modules of the application processors while still hunting for the voice activity.

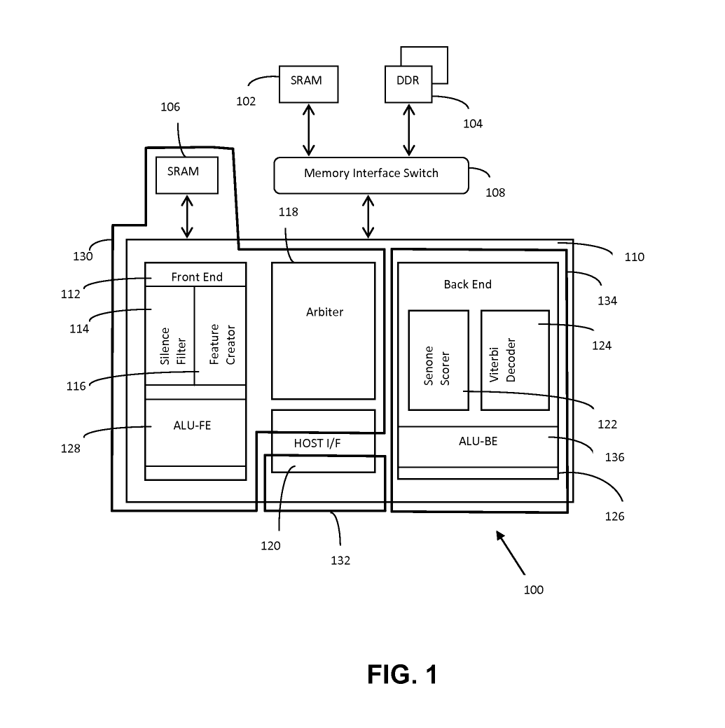

FIG. 1 is a schematic representation of the hardware architecture for speech recognition in accordance with an embodiment of the present invention. The system 100 comprising: a speech recognition hardware 110, a viterbi decoder 124, a senone scorer 122, an arithmetic logic unit (ALU-FE) 128, an arithmetic logic unit (ALU-BE) 136, a backend 126, a silence filter 114, a feature creator 116, a frontend 112, an arbiter 118, a host interface 120, a DDR memory of backend 104, a SRAM of backend 102, a SRAM of frontend 106 and a memory interface switch 108.

In accordance with this and the related objects, the system and the mechanism used to fulfill the purpose as described in the present invention includes: a front end 112 consisting of a silence filter 114 or a voice activity detector for detecting the voice activity and a feature creator 116 in communication with silence filter for splitting the utterance into overlapping frames of 25 ms with an overlap of 15 ms; a back end 126 consisting of two functional blocks that are senone scorer 122 and viterbi decoder 124 used for processing the data; The system 100 has three clock domains: front end 112 along with its SRAM (i.e. FE memory SRAM) works as clock domain1 130, back end 126 works as clock domain2 134, and host interface 120 works on clock domain3 132.

In an embodiment of the proposed invention a speech recognition system 100 incorporating a frontend 112 is provided. The frontend 112 is the part responsible for detection of voice activity and generation of feature vectors that are further used for determining whether keyword was present in the detected voice activity or not. The said front end 112 comprises the silence filter 114, the feature creator 116, the frontend memory 106 and the ALU-FE 128.

The silence filter 114 also known as voice activity detector (VAD), takes the audio inputs in form of 16 Bits data (16 KHz or 8 KHz). It detects the voice activity and propagates those parts of speech further that have voice activity in it. For example a command phrase like “HELLO PND” when spoken preceded and followed by pauses will have its preceding and following pauses removed by silence filter. Typically the silence filter 114 will keep calibrating itself to account for ambient noise and will start passing speech audio downstream when it hears voice beyond preset thresholds over ambient noise This is called voice activity detection or VAD. It'll keep passing the speech audio downstream till it encounters a long programmable pause in speech. The output of silence filter is a full utterance delimited by start and end flags.

After the detection of the voice activity, feature vectors are extracted from the incoming utterance by the feature creator 116. Feature extraction is a step to reduce the dimensionality of the input utterance. The feature creator 116 splits the utterance into frames and extracts features from each frame. The utterance is then changed into a sequence of feature vectors. The feature creator 116 splits the utterance into overlapping 25 ms frames with an overlap of 15 ms. The frames are then subjected to pre-emphasis. Pre emphasis is done in order to compensate the high-frequency part of the speech signal as the voiced segments have more energy at lower frequencies than higher frequencies. A window is then applied to each frame in order to minimize the signal discontinuities at the edges of the frame. Each frame of the speech signal is then subjected to Mel Frequency Cepstral Coefficient (MFCC) generation. The MFCC extraction process generates 13 MFCCs for each frame. These 13 MFCCs are then converted to 39 Dynamic Feature vectors, for each frame, by doing delta and delta-delta operations on them across each frames. Thus, the utterance is converted into a sequence of feature vectors. MFCC are generally used as features in speech recognition systems, such as the systems that can automatically recognize the spoken words, like the numbers spoken into a telephone. These are also used to recognize the speakers based on their voice. MFCCs are also increasingly finding uses in music information retrieval applications such as genre classification, audio similarity measures and many more.

The back end 126 is the part where bulk of processing happens. It has primarily two functional blocks senone scorer 122 and viterbi decoder 124.

The senone scorer 122 calculates scores of active senones i.e. senones corresponding to active hmms in each frame, based on the feature vector values of the frame calculated by front end.

The viterbi decoder 124 processes frames one after other in a time synchronous manner for complete search. It works on the lexical tree and null transaction databases using senone scores calculated by the senone scorer 122. Search space pruning is done at each frame to keep search space within reasonable limits. An intermediate output of this stage is a history entry table. Once the decoding is over, hardware analyzes history entry table by using simple viterbi backtrace. It interrupts the system and provides indication to system if keyword detection was successful or not. This last step (of Back End running Viterbi backtrace can be enabled or disabled). In a situation when this feature is disabled, Output of Back End is a History Entry Table. This table has the complete information to arrive at the spoken utterance and host software uses it to find the spoken phrase or a list of most probable spoken phrases (nBest list). This mode will be used when the Speech Recognition hardware 110 is used in full functional mode i.e if the system has detected the keyword successfully.

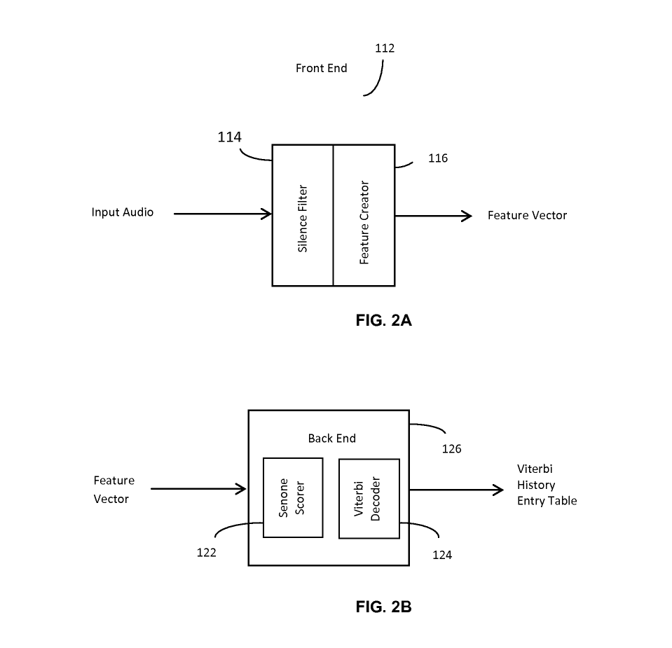

FIG. 2A is a block diagram representing the front end and its components in accordance with an embodiment of the present invention. Referring to FIG. 2A, a front end 112 consists of a silence filter 114 or a voice activity detector for detecting the voice activity and a feature creator 116 in communication with silence filter for splitting the utterance into overlapping frames of 25 ms with an overlap of 15 ms.

The silence filter 114, also known as voice activity detector, is a part of the frontend 112 of speech recognition hardware that remains in always-ON domain in order to detect any voice activity in the spoken audio input. The silence filter 114 takes the audio input in the form of 16 bit data. It keeps calibrating itself to account for the ambient noise and presets a threshold value above the ambient noise. When voice activity above the preset threshold level is detected in the audio input, the parts of the speech having the voice activity in them are then propagated to the feature creator 116. For example a command phrase like “HELLO PND” when spoken preceded and followed by pauses will have its preceding and following pauses removed by silence filter.

After receiving the utterance having the voice activity, the feature creator 116 splits the utterance into overlapping frames of 25 ms with an overlap of 15 ms. After pre emphasis and windowing, 13 MFCCs are generated for each frame. The first and second derivatives (delta and delta-delta operation) of these MFCCs then result in 39 dynamic feature vectors for each of the frame based on the feature vector values calculated by the front end for each frame.

FIG. 2B is a block diagram representing the back end and its components in accordance with an embodiment of the present invention. Referring to FIG. 2B, the back end 126 consists of two functional blocks that are senone scorer 122 and viterbi decoder 124 used for processing the data.

The senone scorer 122, calculates the scores of the active senones that is the senones corresponding to the active HMMS in each frame; the viterbi decoder 124 processes the frames one after other in a time synchronous manner. Using the senone scores calculated by senone scorer 122 it works on Lexical Tree and Null transaction databases and completes the search. Search space pruning is done at each frame to keep search space within reasonable limits. The output of this stage is a history entry table. This table has the complete information to arrive at the spoken utterance. If the viterbi back trace is enabled the hardware analyzes the history entry table by using viterbi back trace that is tracking back the best path to the beginning. It interrupts the system and provides indication to system if keyword detection was successful or not. If the viterbi back trace is not enabled then the output of the Back End 126 is a History Entry Table. The host software then uses this table to find the spoken phrase or a list of most probable spoken phrases using some sophisticated DAG (directed acyclic graph) based algorithms.

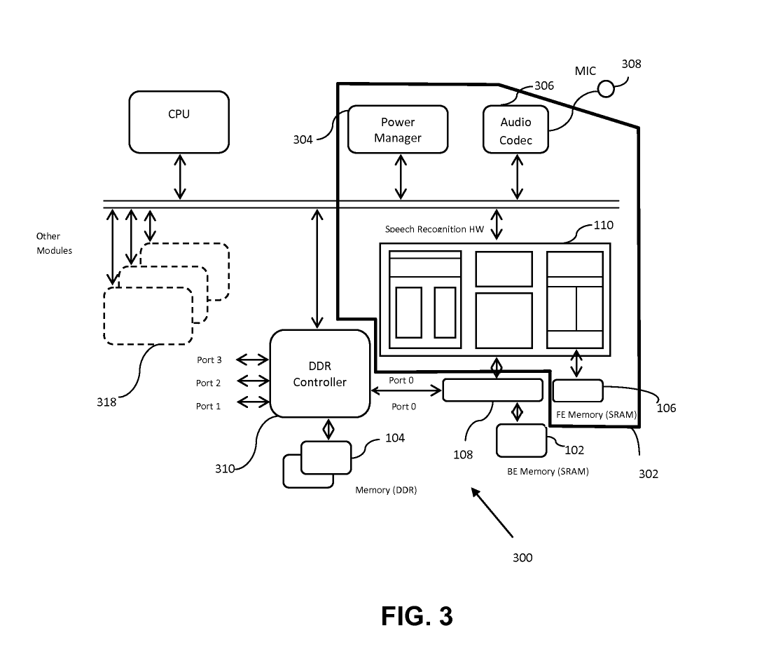

FIG. 3 is a schematic representation of the application processor that utilizes the speech recognition hardware system in accordance with an embodiment of the present invention. The highlighted region 302 in FIG. 3 shows the active, Always ON domain region. This domain needs to always remain active in order to do voice activity detection. The highlighted domain 302 represents the active part of the system 300 that always remains in active mode hunting for the voice activity in the low power state. In this state as shown in FIG. 3 the MIC 308, the audio codec 306, the power manager 304, the speech recognition hardware 110 and the FE memory (SRAM) 106 remains active for voice input.

The system 300 has 3 clock domains. The Front end 112 along with the SRAM 106 works as the clock domain1 130. The Back end 126 works as clock domain2 134 and host interface works as clock domain 3 132. The Clock domain1 130 and domain2 134 are same, the only difference is gating. Clock to domain2 134 is a gated version of clock to domain1 130 and so can be independently disabled.

According to the Keyword recognition scheme, in order to reduce the power consumption to quite a lower level when the system remains in idle state for more than a pre-specified duration, the system gracefully deactivates different modules of application processor and the clock domain2 134 is stopped (gated), frequency of clocks to domain1 130 and domain3 132 are reduced to a range of about 100 Khz. At this stage, hardware i.e. the Front End 112 stays in always active mode to hunt for voice activity. Audio data is continuously pumped into the Front End 112 under the control system of power manager 304 and it keeps doing calibration and voice activity detection.

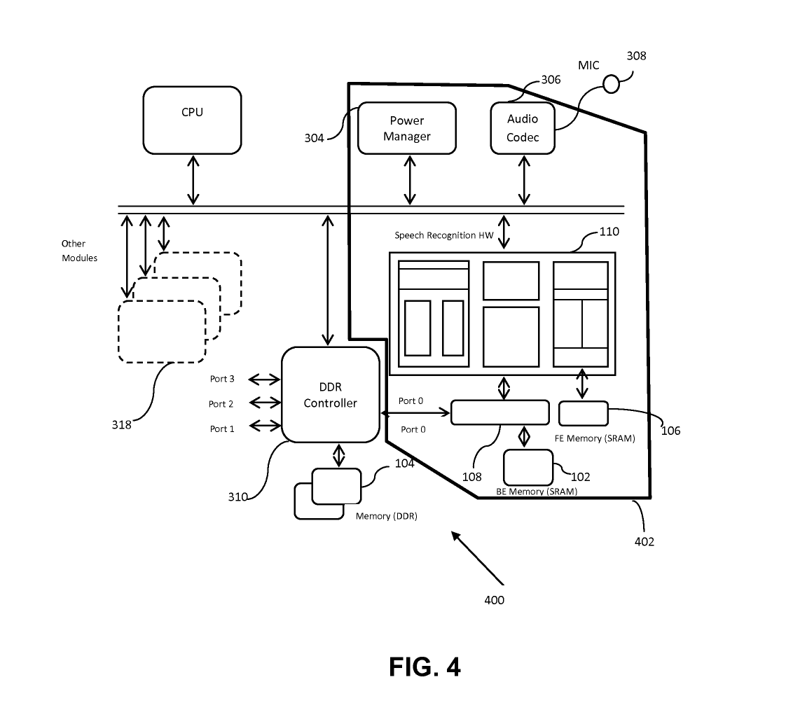

FIG. 4 is a schematic representation of the application processor that utilizes the speech recognition hardware system in accordance with an embodiment of the present invention. The highlighted region in FIG. 4 shows the ON Domain for keyword detection after voice activity is detected where system works out of SRAM for keyword detection after the voice activity is detected. Referring to FIG. 4, the highlighted domain 402 shows the component that goes into the active state when voice signal are detected activating the memory interface switch 108 and BE memory (SRAM) 102 for detection of the keyword.

Upon detection of the voice activity by the system 400, an indication from the front End 112 is provided to the system power manager 304, after that clock to the domain1 130 and the domain3 132 are jacked up to the range of about 50 Mhz from the range of about 100 Khz. Here voltage jacking will also be done if voltage scaling is used, followed by the activation of the back end clock to domain2 134. After domain2 134 is started, the BE SRAM 102 is activated. Memory subsystem is started with appropriate clock with Bandwidth of approx. 20 MB/Sec.

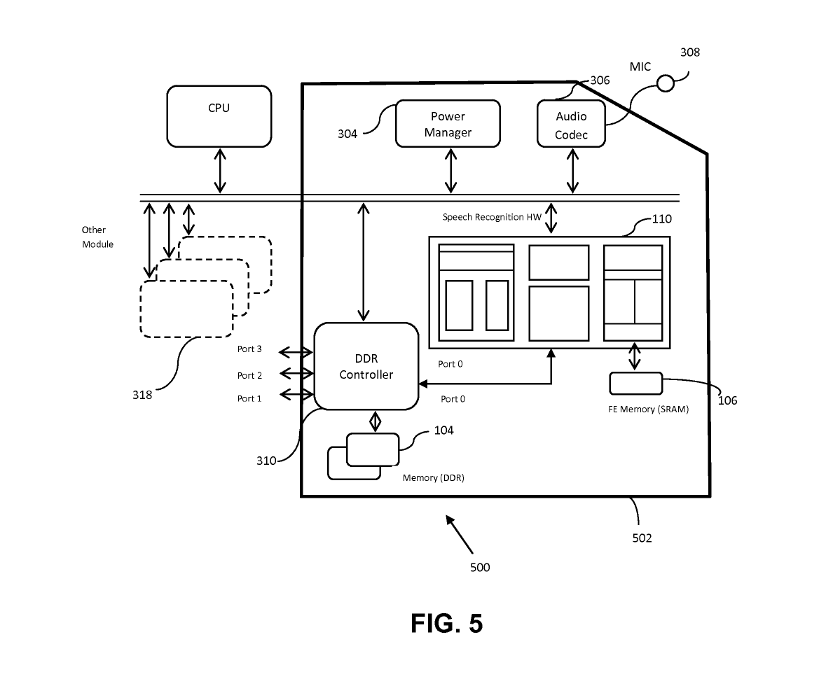

FIG. 5 is a schematic representation of the application processor that utilizes the speech recognition hardware system in accordance with an embodiment of the present invention. The highlighted region in FIG. 5 shows the ON Domain for keyword detection after voice activity is detected where system works out of the DDR for keyword detection after the voice activity is detected. The highlighted domain 502 of the system 500 represents the active state of the system 500 after the detection of the keyword. Here in this stage system works out of DDR 310 for keyword detection after the voice activity detection has happened. After the activation of the memory subsystem and the BE SRAM 102 or BE DDR 104, Back End databases are initialized in either BE SRAM 102 or BE DDR 104 (as the case may be) for recognition of the keyword inputted by the audio codec and finally handshaking between the back end 126 and the front end 112 is started for data input and utterance decoding is started.

After utterance decoding is completed, the hardware interrupts the power manager 304 to indicate the detection of the keyword in form of decoded utterance. If the decoded utterance is found to be the keyword the system then enters into the full performance mode and is further ready for doing more sophisticated speech recognition.

Furthermore, if decoded utterance is not found to be the keyword or if no activity is detected again for a preset duration, then system again goes back to the low power state by stopping down the back end clock domain2 134 followed by the reduction in the frequencies of clocks to the domain1 130 and the domain3 132.

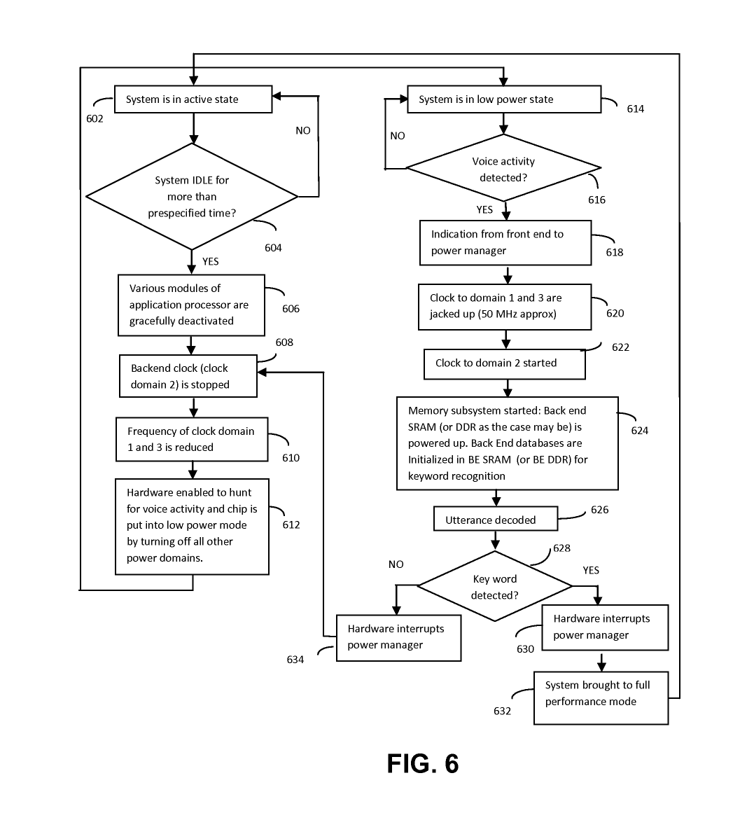

FIG. 6 is a flowchart illustrating the mechanism for low power keyword based hands free wake-up in accordance with an embodiment of the present invention. Referring to FIG. 6, the system is in active state 602 and is tracked whether the system remains idle for more than pre-specified time, in step 604. The system continuously remains to be in active state if it does not remain idle for more than a pre-specified time. If the system remains idle for more than a pre-specified time, then the various modules of the application processor are gracefully deactivated 606. The backend clock (clock domain2) is stopped 608 and the frequency of clock domain1 and 3 is reduced 610. In the next step 612, the hardware is enabled to hunt for voice activity and the application processor chip is put into low power mode by turning off all other power domains. This will lead to the system to come down in low power state as shown in step 614.

If the system is in low power step 614, than it continuously hunt for voice activity, if no voice activity is detected, than the system maintain itself in the low power state 614. However, If the voice activity is detected, than an indication will be sent from front end to power manager in step 618, that results in jacking up of clock domain1 and clock domain3 upto 50 MHz approx as shown in step 620. Further the clock to domain2 get started 622. In the next step 624 memory subsystem get started. The back end SRAM (or DDR as the case may be) is powered up and back end databases are initialized in back end SARM (or DDR) for keyword recognition. Further the utterance is decoded in step 626 and checked for keyword detection in step 628. If the keyword is detected then the power manager is interrupted 630 and system is brought to full performance mode 632 and it will remains in active state 602. However if the keyword is not detected in the utterance than the hardware interrupts power manager 634 and the system goes to step 608 where backend clock (clock domain2) is stopped and frequency of clock domain1 and clock domain3 is reduced.

### Example 1

### Dictionary File for a Keyword Application (Keyword is HELLO SIMSIM)

HELLO HH AH L OW
HELLO (2) HH EH L OW
SIMSIM S IH M S IH M
G1 AA
G2 AE
G3 AH
G4 AO
G5 AW
G6 AY
G7 B
G8 CH
G9 D
G10 DH
G11 EH
G12 ER
G13 EY
G14 F
G15 G
G16 HH
G17 IH
G18 IY
G19 JH
G20 K
G21 L
G22 M
G23 N
G24 NG
G25 OW
G26 OY
G27 P
G28 R
G29 S
G30 SH
G31 T
G32 TH
G33 UH
G34 UW
G35 V
G36 W
G37 Y
G38 Z
G39 ZH

### Example 2

### Grammar File for a Keyword Application (Keyword is HELLO SIMSIM)

#JSGF V1.0;
grammarkewword_test;
public<command> = [<garbage_loop>] [<keyword>] [<garbage_loop>];
<option_1> = <keyword>;
<option_2> = <garbage_loop><keyword>;
<option_3> = <keyword><garbage_loop>;
<option_4> = <garbage_loop><keyword><garbage_loop>;
<option_5> = <garbage_loop>;
<keyword> = (HELLO SIMSIM);
<garbage_loop> = (G1 | G2 | G3 | G4 | G5 | G6 | G7 | G8 |
G9 | G10 | G11 | G12 | G13 | G14 | G15 | G16 | G17 | G18 | G19 |
G20 | G21 | G22 | G23 | G24 | G25 | G26 | G27 | G28 | G29 | G30 | G31 |
G32 | G33 | G34 | G35 | G36 | G37 | G38 | G39) +;

### Example 3

### Dictionary File for a Simple Camera Application

AM EY EH M
APRIL EY P R AH L
AUGUST AA G AH S T
AUGUST (2) AO G AH S T
AUTO AO T OW
BEACH B IY CH
CLICK K L IH K
DATE D EY T
DECEMBER D IH S EH M B ER
DISPLAY D IH S P L EY
EASY IY Z IY
EIGHT EY T
EIGHTEEN EY T IY N
EIGHTEENTH EY T IY N TH
EIGHTH EY T TH
EIGHTH(2) EY TH
EIGHTY EY T IY
ELEVEN IH L EH V AH N
ELEVEN(2) IY L EH V AH N
ELEVENTH IH L EH V AH N TH
ELEVENTH (2) IY L EH V AH N TH
FEBRUARY F EH B Y UW W EH R IY
FEBRUARY (2) F EH B R UW W EH R IY
FIFTEEN F IH F T IY N
FIFTEENTH F IH F T IY N TH
FIFTH F IH F TH
FIFTH (2) F IH TH
FIFTY F IH F T IY
FIREWORKS F AY R W ER K S
FIRST F ER S T
FIVE F AY V
FORTY F AO R T IY
FOUR F AO R
FOURTEEN F AO R T IY N
FOURTEENTH F AO R T IY N TH
FOURTH F AO R TH
GOURMET G UH R M EY
ISO AY AE S OW
JANUARY JH AE N Y UW EH R IY
JULY JH UW L AY
JULY (2) JH AH L AY
JUNE JH UW N
LANDSCAPE L AE N D S K EY P
LANDSCAPE (2) L AE N S K EY P
MARCH M AA R CH
MAY M EY
MODE M OW D
MOVIE M UW V IY
NINE N AY N
NINETEEN N AY N T IY N
NINETEENTH N AY N T IY N TH
NINETY N AY N T IY
NINTH N AY N TH
NOVEMBER N OW V EH M B ER
OCTOBER AA K T OW B ER
ONE W AH N
ONE (2) HH W AH N
PANORAMA P AE N ER AE M AH
PETS P EH T S
PICTURE P IH K CH ER
PM P IY EH M
PORTRAIT P AO R T R AH T
READY R EH D IY
REDO R IY D UW
SCENE S IY N
SECOND S EH K AH N D
SECOND (2) S EH K AH N
SELECTION S AH L EH K SH AH N
SEPTEMBER S EH P T EH M B ER
SET S EH T
SEVENS EH V AH N
SEVENTEEN S EH V AH N T IY N
SEVENTEENTH S EH V AH N T IY N TH
SEVENTH S EH V AH N TH
SEVENTY S EH V AH N T IY
SEVENTY (2) S EH V AH N IY
SHOOT SH UW T
SIX S IH K S
SIXTEEN S IH K S T IY N
SIXTEENTH S IH K S T IY N TH
SIXTH S IH K S TH
SIXTY S IH K S T IY
SNAP S N AE P
SNOW S N OW
SOFT S AA F T
SOFT (2) S AO F T
SPORTS S P AO R T S
TEN T EH N
TENTH T EH N TH
THIRD TH ER D
THIRTEEN TH ER T IY N
THIRTEENTH TH ER T IY N TH
THIRTIETH TH ER T IY AH TH
THIRTIETH (2) TH ER T IY IH TH
THIRTY TH ER D IY
THIRTY (2) TH ER T IY
THREE TH R IY
TIME T AY M
TWELFTH T W EH L F TH
TWELVE T W EH L V
TWENTIETH T W EH N T IY AH TH
TWENTIETH (2) T W EH N T IY IH TH
TWENTIETH (3) T W EH N IY AH TH
TWENTIETH (4) T W EH N IY IH TH
TWENTY T W EH N T IY
TWENTY (2) T W EH N IY
TWILIGHT T W AY L AY T
TWO T UW
ZERO Z IH R OW
ZERO (2) Z IY R OW

### Example 4

### The Phoneme Set

The current phoneme set has 39 phonemes. This phoneme (or more accurately, phone) set is based on the ARPAbet symbol set developed for speech recognition uses.

Phoneme Example Translation

AA odd AA D
AE at AE T
AH hut HH AH T
AO ought AO T
AW cow K AW
AY hide HH AY D
B be B IY
CH cheese CH IY Z
D dee D IY
DH thee DH IY
EH Ed EH D
ER hurt HH ER T
EY ate EY T
F fee F IY
G green G R IY N
HH he HH IY
IH it IH T
IY eat IY T
JH gee JH IY
K key K IY
L lee L IY
M me M IY
N knee N IY
NG ping P IH NG
OW oat OW T
OY toy T OY
P pee P IY
R read R IY D
S sea S IY
SH she SH IY
T tea T IY
TH theta TH EY T AH
UH hood HH UH D
UW two T UW
V vee V IY
W we W IY
Y yield Y IY L D
Z zee Z IY
ZH seizure S IY ZH ER

### Example 5

### Grammar File for a Simple Camera Application

#JSGF V1.0;
grammarsony_enhanced;
public<command> = <picture_mode> | <display_mode> | <set_time_full> | <am_pm> |
<set_date_full> | <scene_selection>
| <easy_shoot> | <auto> | <panorama> | <movie> | <iso> | <soft_snap> | <sports>
| <landscape> | <pets> | <gourmet> | <twilight> | <portrait> | <beach> | <snow> |
<fireworks>
| <zero_to_nintynine>
| <month>
| <ready> | <click> | <redo>;
<picture_mode> = PICTURE [MODE];
<display_mode> = DISPLAY [MODE];
<set_time_full> = <set_time><time_hour>[ <time_minute_sec>] [<am_pm>];
<set_date_full> = <set_date><date><month> [<year>];
<set_time> = SET TIME;
<set_date> = SET DATE;
<scene_selection> = <scene_selection0> | <scene_selection1> | <scene_selection2>;
<scene_selection0> = SCENE [SELECTION];
<scene_selection1> = [SCENE] SELECTION;
<scene_selection2> = SCENE SELECTION;
<easy_shoot> = <easy_shoot0> | <easy_shoot1> | <easy_shoot2>;
<easy_shoot0> = EASY [SHOOT];
<easy_shoot1> = [EASY] SHOOT;
<easy_shoot2> = EASY SHOOT;
<auto> = AUTO;
<panorama> = PANORAMA;
<movie> = MOVIE;
<iso> = ISO;
<soft_snap> = <soft_snap0> | <soft_snap1> | <soft_snap2>;
<soft_snap0> = SOFT SNAP;
<soft_snap1> = [SOFT] SNAP;
<soft_snap2> = SOFT [SNAP];
<sports> = SPORTS;
<landscape> = LANDSCAPE;
<pets> = PETS;
<gourmet> = GOURMET;
<twilight> = TWILIGHT;
<portrait> = PORTRAIT;
<beach> = BEACH;
<snow> = SNOW;
<fireworks> = FIREWORKS;
<am_pm> = AM | PM;
<time_hour> = <zero> | <units> | <ten_eleven_twelve> ;
<time_minute_sec> = <zero> | <units> | <ten_eleven_twelve> | <teens> |
(<twenty_to_fifty> [<units>]);
<date> = <units> | <ten_eleven_twelve> | <teens> | (<twenty_to_thirty> [<units>]) |
<units_alt>
| <ten_eleven_twelve_alt> | <teens_alt> | <twenty_to_thirty_alt> | (<twenty_to_thirty>
[<units_alt>]);
<month> = <january> | <february> | <march> | <april> | <may> | <june> | <july> |
<august> | <september>
| <october> | <november> | <december>;
<zero_to_nintynine> = <zero> | <units> | <ten_eleven_twelve> | <teens> |
(<twenty_to_fifty> [<units>])
| (<sixty_and_up> [<units>]);
<year> = <zero_to_nintynine><zero_to_nintynine>;
<zero> = ZERO;
<units> = ONE | TWO | THREE | FOUR | FIVE | SIX | SEVEN | EIGHT | NINE ;
<units_alt> = FIRST | SECOND | THIRD | FOURTH | FIFTH | SIXTH | SEVENTH |
EIGHTH | NINTH;
<ten_eleven_twelve> = TEN | ELEVEN | TWELVE;
<ten_eleven_twelve_alt> = TENTH | ELEVENTH | TWELFTH;
<teens> = THIRTEEN | FOURTEEN | FIFTEEN | SIXTEEN | SEVENTEEN |
EIGHTEEN | NINETEEN;
<teens_alt> = THIRTEENTH | FOURTEENTH | FIFTEENTH | SIXTEENTH |
SEVENTEENTH
| EIGHTEENTH | NINETEENTH;
<twenty_to_fifty> = TWENTY | THIRTY | FORTY | FIFTY;
<twenty_to_thirty> = TWENTY | THIRTY;
<twenty_to_thirty_alt> = TWENTIETH | THIRTIETH;
<sixty_and_up> = SIXTY | SEVENTY | EIGHTY | NINETY;
<january> = JANUARY;
<february> = FEBRUARY;
<march> = MARCH;
<april> = APRIL;
<may> = MAY;
<june> = JUNE;
<july> = JULY;
<august> = AUGUST;
<september> = SEPTEMBER;
<october> = OCTOBER;
<november> = NOVEMBER;
<december> = DECEMBER;
<ready> = READY;
<click> = CLICK;
<redo> = REDO;

In accordance with an embodiment of the present invention, the invention finds application in areas including voice dialing, robotics, voice activated consumer products, interactive voice response applications, low power high performance voice enabled embedded applications, video games and hands free computing.

We claim:

1. A method for voice based activation of an electronic system comprising:
putting the system into low power mode when the system remains idle for more than a pre-specified time;
maintaining a database of preselected keywords;
continuously searching for voice activity in low power mode;
capturing the voice activity and determining whether a match exists between said voice activity and at least one of said keywords while remaining in low power mode;
activating the electronic system if at least one match exists between said voice activity and keywords;
remaining in low power mode if the match does not exist between said voice activity and said keywords.

2. The method of claim 1 wherein the voice activity is captured using a specialized speech recognition hardware.

3. The method of claim 1 wherein the low power mode is attained by keeping only the voice activity detector ON in low performance.

4. The method of claim 1 wherein the keywords are the words to be used for activation of the electronic device.

5. The method of claim 1 wherein the keywords are generated by the user and are stored in the storing database.

6. A low power keyword based speech recognition system for activating an electronic device comprising:
a first module for detecting a voice activity;
a second module for keyword recognition;
a processor in communication with the first module and the second module, wherein the said processor deactivates the said second module and reduce the frequency of said first module when the system remains idle beyond a pre-specified time;
a power manager for receiving the feedback from the said first module, wherein the said power manager activates the said second module and increases the frequency of said first module on detection of said voice activity;
an application programming interface in the said second module to determine whether a match exist between the said voice activity and said keywords, wherein on a match detection, the said application programming interface brings the electronic device to full power mode.

7. The system as claimed in claim 6 wherein the frequency of the said first module is in range of 100 kHz and requires SRAM in the range of 80 KB with a bandwidth of 200 KB/s for doing voice activity detection.

8. The system as claimed in claim 6 wherein the frequency of the said second module is in the range of 50 Mhz and requires memory in the range of 2.7 MB with a bandwidth of 20 MB/s.

9. The system of claim 6 wherein the said first module remains in ON state to hunt for voice activity.

10. The system of claim 6 wherein the said second module gets activated on detection of voice activity.

11. The system of claim 6 wherein the power manager activates the said second module on detection of the voice activity by the said first module.

12. The system of claim 6 wherein the application programming interface brings the device to full power mode if the match occurs between said keywords and said voice activity.

13. A method for activating an electronic device using a speech recognition system comprising:
maintaining a database of preselected keywords;
when the electronic device remains idle for a pre-specified time, bringing the system in sleep mode by keeping a first module meant for voice activity detection in low frequency mode and deactivating a second module meant for keyword recognition;
continuously searching for voice activity by said first module in low frequency mode;
activating the said second module on detection of said voice activity;
determining whether a match exists between said voice activity and at least one of said keywords;
bringing the electronic device to full power mode, if a match exist between said voice activity and said keywords;
putting back the system in sleep mode, if the match does not exist between said voice activity and at least one keywords.

14. The method of claim 13 wherein the frequency of the said first module is in range of 100 kHz and requires around 80 KB SRAM with a bandwidth of 200 KB/s.

15. The method of claim 13 wherein the frequency of the said second module is in the range of 50 Mhz and requires memory in the range of 2.7 MB with a bandwidth of 20 MB/s.

16. The method of claim 13 wherein the first module is a voice activity detector.

17. The method of claim 13 wherein keywords are the words used to activate the electronic device.

18. The method of claim 13 wherein the keywords are predefined by the user and are stored in the database.
